(19) United States
(12) Patent Application Publication
(10) Pub. No.: US 2019/0351754 A1
(43) Pub. Date: Nov. 21, 2019

(54) PROPELLING EQUIPMENT FOR A MOTOR VEHICLE

(71) Applicant: FINEMECH CO., LTD., Kanagawa-ken (JP)

(72) Inventor: Kazuyoshi HIRAIWA, Kanagawa-ken (JP)

(21) Appl. No.: 16/415,091

(22) Filed: May 17, 2019

(30) Foreign Application Priority Data
May 18, 2018 (JP) 2018-096083
Jul. 3, 2018 (JP) 2018-126587

(51) Int. Cl. B60K 6/46; F16H 37/02; B60K 6/387; B60K 6/365

(52) U.S. Cl. CPC B60K 6/46; F16H 37/022; F16H 2037/023; B60K 6/365; B60K 6/387

(57) ABSTRACT

A propelling equipment has an engine, a first motor/generator, a second motor/generator and a planetary gear train. A common velocity diagrammatic view has at least four members. One of the rotational members corresponds to a second member, one of the rotational members corresponding to a third member, and one of the rotational members corresponding to a fourth member connected with the second motor/generator. One of the second member and the fourth member corresponds to a low-seed step fixed ratio member, a fixed transmission ratio at a low-speed step being obtained by fixing the low-seed step fixed ratio member on a stationary part of a case. The fourth member is fixable to the stationary part when the first member is fixed or rotates at a low speed to obtain a speed increasing transmission ratio.

### BACKGROUND OF THE INVENTION

### 1. Field of the Invention

The present invention relates to a propelling equipment for a motor vehicle that is equipped with an internal combustion engine and a motor/generator (hereinafter referred to as “MG”) for at least one of them to propel the motor vehicle.

### 2. Description of the Related Art

A conventional propelling equipment for a motor vehicle of this kind is disclosed in U.S. Pat. No. 7,192,323. This propelling equipment has two sets of planetary gears and two MGs.

It has an advantage of providing a relatively simple construction and a wide range of transmission ratios. However, in the above known conventional propelling equipment, there is a problem in that a rotational speed of one of the MGs becomes high when a transmission ratio (a rotational speed of an input shaft/a rotational speed of an output shaft) is small when the motor vehicle runs at a high speed and so forth (the transmission ratio being small). This deteriorates fuel consumption of the motor vehicle.

It is, therefore, an object of the present invention to provide a propelling equipment for a motor vehicle which overcomes the foregoing drawbacks and can improve fuel consumption when a transmission ratio of the propelling equipment is small.

### SUMMARY OF THE INVENTION

According to an aspect of the present invention there is provided a propelling equipment for a motor vehicle, the propelling equipment includes an internal combustion engine; an input shaft that is capable of receiving power from the internal combustion engine; an output shaft; a first motor/generator; a second motor/generator; a case having a stationary part; and a planetary gear train that is arranged between the input shaft and the output shaft, the planetary gear train being capable of changing a rotational velocity of the input shaft to a rotational velocity of the output shaft, the planetary gear train having a first planetary gear group that includes a first planetary gear set and a second planetary gear group that includes a second planetary gear set, and the first planetary gear group and the second planetary gear group being provided with at least three rotational elements, respectively. The rotational elements of the first planetary gear group and the second planetary gear group are combined to correspond to at least four rotational members so that rotational velocities of the rotational members are geometrically expressed by a common velocity diagrammatic view. Velocity axes expressing the rotational members are arranged along on a lateral axis of the common velocity diagrammatic view from one edge to the other edge at intervals according to teeth ratios of the planetary gear sets so that the velocity axes are set as a first member, a second member, a third member and a fourth member from the one edge to the other edge in order in the common velocity diagrammatic view. The rotational members of the first planetary gear group are constructed so that the first member is connected with the first motor/generator, the second member is connectable with the input shaft, and the third member is connected with the output shaft. The rotational members of the second planetary gear group are constructed so that one of the rotational members corresponds to the second member, one of the rotational members corresponds to the third member, and one of the rotational members corresponds to the fourth member connected with the second motor/generator. One of the second member and the fourth member corresponds to a low-seed step fixed ratio member, and a fixed transmission ratio at the low-speed step is obtained by fixing the low-seed step fixed ratio member on the stationary part. The fourth member is fixable on the stationary part when the first member is fixed on the stationary part or rotates at a low speed to obtain a speed increasing transmission ratio.

### BRIEF DESCRIPTION OF THE DRAWINGS

The objects, features and advantages of the present invention will become apparent as the description proceeds when taken in conjunction with the accompanying drawings, in which:

FIG. 1 is a view showing a skeleton of a main part of a propelling equipment for a motor vehicle of a first embodiment according to the present invention;

FIG. 2 is an operational table of the first embodiment;

FIG. 3 is a common velocity diagrammatic view of the first embodiment;

FIG. 4 is another common velocity diagrammatic view of the first embodiment;

FIG. 5 is a skeleton of a main part of a propelling equipment for a motor vehicle of a second embodiment according to the present invention;

FIG. 6 is an operational table of the second embodiment;

FIG. 7 is a common velocity diagrammatic view of the second embodiment;

FIG. 8 is another common velocity diagrammatic view of the second embodiment;

FIG. 9 is a skeleton of a main part of a propelling equipment for a motor vehicle of a third embodiment according to the present invention;

FIG. 10 is a common velocity diagrammatic view of the third embodiment;

FIG. 11 is a skeleton of a main part of a propelling equipment for a motor vehicle of a fourth embodiment according to the present invention;

FIG. 12 is an operational table of the fourth embodiment;

FIG. 13 is a common velocity diagrammatic view of the fourth embodiment; and

FIG. 14 is another common velocity diagrammatic view of the fourth embodiment.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

### First Embodiment

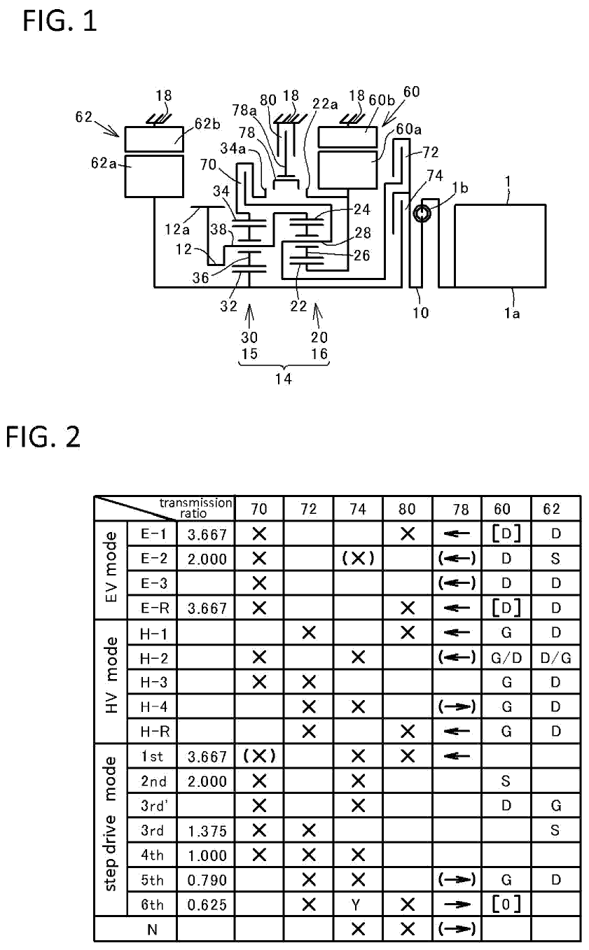

Referring to FIG. 1 of the drawing, there is shown a first preferred embodiment of a propelling equipment for a motor vehicle according to the present invention.

FIG. 1 shows a skeleton of a main part of the propelling equipment, which only shows an upper half part above an input shaft 10, omitting a lower half part thereof.

The propelling equipment has an internal combustion engine 1, and its crank shaft 1a is connected with the input shaft 10 through a damper 1b. An output shaft 12 is arranged in coaxial with the input shaft 10. The output shaft 12 is integrally formed with an output gear 12a, which drives not-shown wheels through a not-shown differential gears.

A planetary gear train 14 includes two planetary gear group consisting of a first planetary gear set 20 and a second planetary gear set 30. The planetary gear train 14 is arranged between the input shaft 10 and the output shaft 12. Each of the first planetary gear set 10 and the second planetary gear set 30 is constructed as a single pinion type, respectively, and they are similarly constructed.

That is, the first planetary gear set 20 is constructed by three rotational elements consisting of a first sun gear 22, a first ring gear 24, and a first carrier 28 rotatably supporting a plurality of first pinions 26 that are engaged with the first sun gear 22 and the first ring gear 24. Similarly, the second planetary gear set 30 is constructed by three rotational elements consisting of a second sun gear 32, a second ring gear 34, and a second carrier 38 rotatably supporting a plurality of second pinions 36 that are engaged with the second sun gear 32 and the second ring gear 34.

Herein, the first planetary gear set 20 functions as a first planetary gear group 15 of the invention, and the second planetary gear set 30 functions as a second planetary gear group 16.

Next, a connecting relationship between the rotational elements and rotational members, which will be later explained, will be described. The first sun gear 22 functions as a first member of the invention. The first member is connected with a first rotator 60a of a first MG 60, and is capable of being fixed on a case (a stationary part) 18 by a first brake 80 through a sleeve 78 and a holding member 78a. Incidentally, a stator 60b of the first MG 60 is fixed to the case 18.

The first carrier 28 and the second ring gear 34 function as a second member of the invention. They are capable of connecting with each other by a first clutch 70, and the first carrier 28 is capable of connecting with the input shaft 10 through the second clutch 72. The second ring gear 34 is capable of being fixed to the case 18 by a first brake 80 through the sleeve 78 and the holding member 78a. The second ring gear 34 functions as a low-speed step holding member of the invention.

Herein, the sleeve 78 is capable of moving in an axial direction, being engaged with the holding member 78a. In FIG. 1, when it moves toward the left side, it is engaged with dog teeth 34a of the second ring gear 34, while, when it moves toward the right side, it is engaged with dog teeth 22a of the first sun gear 22. Accordingly to the moving directions of the sleeve 78, the first brake 80 can selectively fix the second ring gear 34 or the first sun gear 22 on the case 18.

The first ring gear 24 and the second carrier 38 function as a third member of the invention. They are connected with the output shaft 12. The second sun gear 32 functions as a fourth member M4 of the invention. The second sun gear 32 is connected with a rotator 62a of a second MG 62, and it is capable of connecting with the input shaft 10 through a third clutch 74. Incidentally, a stator 62b of the second MG 62 is fixed on the case 18. The first to fourth members are aligned in order on the lateral axis of the common velocity diagrammatic view toward the right side or the left side.

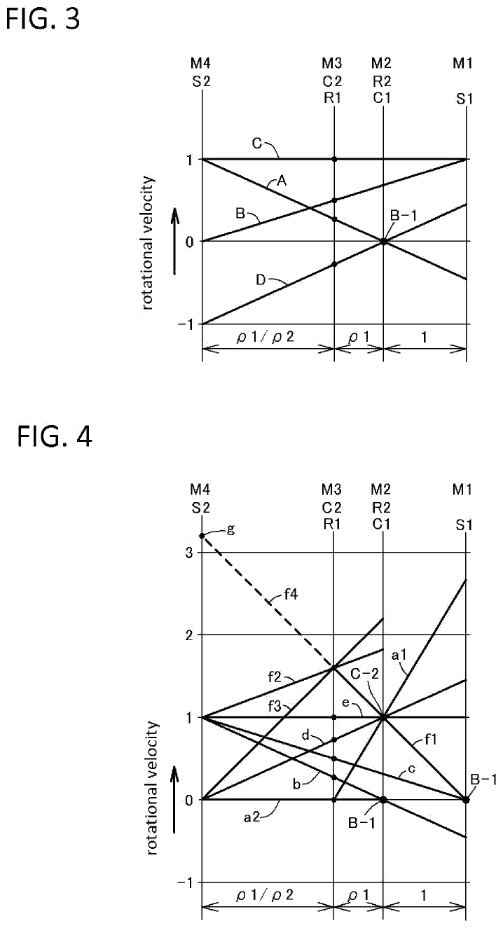

Next, an operation of the propelling equipment will be described with reference to an operational table shown in FIG. 2 and common velocity diagrammatic views shown in FIGS. 3 and 4. In the operational table of FIG. 2, a plurality of drive modes, which will be later described, are allocated in a longitudinal direction in the operational table, while the respective transmission ratios and applied elements such as the clutches 70, 72 and 74, the sleeve 78, the brake 80, and two MGs 60 and 62 are allocated in a lateral direction in the operational table.

In the operational table, a mark × indicates “fastened”, a mark Y indicates “there is a case where it is applied”. The moving directions of sleeve 78 are indicated by arrows. In the MGs, a state where it or they generate electric power is indicated by “G”, a state where it or they drive is indicated by “D”, and a state where it or they are held to function as a brake is indicated by “S”. “D/G” means that it or they vary between the electrically generation and driving according to the transmission ratio. An enclosed part of [ ] means that there is a case where it or they drive or generate. Incidentally, in the operational table, a state where the MG is held is indicated by “0”, and [0] means that there is a case where it is held. [×] means that it is not necessary to transmit the power although the applied element or the applied elements are fixed.

FIGS. 3 and 4 shows the common velocity diagrammatical views. The common velocity diagrammatical views show rotational velocities of rotational elements when the rotational velocity of the input shaft 10 is set one in the longitudinal direction for convenience sake of calculation. The rotational members are allocated at intervals according to teeth ratios ρ (teeth number of sun gear/teeth number of ring gear) of the first planetary gear set 20 and the second planetary gear set 30 in the lateral direction, and each velocity axis is shown in the latitudinal direction. Incidentally, the rotational velocity of one of the MGs 60 and 62 is indicated as 1 or −1 in an EV modes, which will be later described for reasons of expediency.

The symbols on an upper side of each axes of the common velocity diagrammatic views are indicated as follows: the first member as M1, and the second member as M2. The sun gears are indicated as S, the ring gears as R and the carriers as C, where the rotational elements of the first planetary gear set 20 are indicated by adding an index 1 to the respective symbols of the rotational elements of the first planetary gear set 20, and the rotational members of the second planetary gear set 30 are indicated by adding an index 2 to the respective symbols of the rotational elements of the second planetary gear set 30.

Herein, the teeth ratios ρ of the first and second planetary gears 20 and 30, which are used to plot the velocity lines in the common velocity diagrammatic views, are set as follows in this embodiment. The teeth ratio ρ1 of the first planetary gear set 20 is set to 0.600, and the teeth ratio ρ2 of the second planetary gear set 30 is set to 0.375, for example. Hereinafter, the computation of a part of the transmission ratios will be described based on these teeth ratios.

In the common velocity diagrammatic views, each longitudinal directional position of intersection point of the velocity axis expressing each rotational member (a longitudinal axis) and a velocity line (a thick line) indicates the rotational velocity of each rotational member. Accordingly, the rotational velocities of the output shaft 12 are the longitudinal directional positions of the intersection points of the velocity axis indicated by M3 and the velocity lines, respectively. The transmission ratios can be geometrically computed from the common velocity diagrammatic view as the transmission ratios between the rotational velocities of the output shaft 12 and the rotational velocities at M2, M4 and M1, or those of the input shaft 10, the first MG 60 and the second MG 62, respectively.

Incidentally, the propelling equipment shown in FIG. 1 is equipped with a battery, an oil pump, various kinds of sensors, a controller, an inverter, a shift lever, a plurality actuators and so forth, if necessary, to bring the propelling equipment into operation as not shown. The operations described below are carried out based on instructions from the controller. The rotation of the same directional rotation as the directional rotation of the internal combustion engine 1 is defined as a “positive rotation”, and the rotation in the reverse rotational direction is defined as a “negative rotation”.

The propelling equipment has a drive in an “EV mode” where the internal combustion engine 1 is stopped and the first MG 60 and/or the second MG 62 drives the motor vehicle and a drive in a “Hybrid (HV) mode” where the internal combustion engine 1 and the first MG 60 and/or the second MG 62 drive the motor vehicle. The HV mode includes a step drive mode which will be later described.

First, the EV mode where only the first MG 60 and/or the second MG 62 drives or brakes will be described. Incidentally, the EV mode is expressed in the common velocity diagrammatic view of FIG. 3. The EV mode includes four drive modes: an E-1 mode, an E-2 mode, an E-3 mode and an E-R mode.

The E-1 mode is executed by moving the sleeve 78 toward the left side in FIG. 1 and applying the first clutch 70 and the first brake 80, being expressed by the velocity line A in FIG. 3. There are two cases in the E-1 mode: a case where only the second MG 62 drives, and a case where the both of the first MG 60 and the second MG 62 drive. The transmission ratio (the rotational velocity of the second MG 62/the rotational velocity of the output shaft 12) when only the second MG 62 drive is (1+ρ2)/ρ2, where it becomes 3.667 at the teeth ratios set above. The transmission ratio (the rotational velocity of the first MG 60/the rotational velocity of the output shaft 12) when the first MG 60 drives is −1/ρ1, where it becomes −1.667 at the teeth ratios set above. That is, the first MG 60 rotates in the reverse rotational direction when the motor vehicle moves forward.

The E-2 mode, as expressed by the velocity line B, can be obtained by applying only the first clutch 70 and driving the first MG 60, while the second MG62 is stopped. The transmission ratio in the E-2 mode is {ρ2(1+ρ1)+ρ1}/ρ1, where it becomes 2.0 at the teeth ratios set above. In this E-2 mode, when the third clutch 74 is applied, the internal combustion engine 1 can be started by the second MG 62 from a drive state of the E-2 mode.

The E-3 mode can be obtained by applying only the first clutch 70 and driving the both of the first MG 60 and the second MGb62 as expressed by the velocity line C. The velocity line C expresses a case where the first MG 60 drives at the same rotational velocity as the second MG 62. Of cause, they can drive at different velocities.

The E-R mode where the motor vehicle moves astern can be obtained by applying the first clutch 70 and the first brake 80 and driving the first MG and the second MG 62 as expressed by the velocity line D. It is the same operation as that of the E-1, while the first MG 60 and the second MG 62 are driven in the reverse direction opposite to the E-1 mode.

In the above-described explanation, the first MG 6o and the second MG 62 drive, but it is possible that they can recover braking energy during the motor vehicle running The electric power which the first MG 60 and the second MG 62 generate is stored and prepared for next acceleration.

Next, the HV mode will be described with reference to the common velocity diagrammatic view of FIG. 4. The HV mode has five drive modes: an H-1 mode, an H-2 mode, an H-3 mode, an H-4 mode and an H-R mode. In these modes, the propelling equipment can be driven at a continuously variable transmission ratio. It can also drive at the step drive mode, which can be included in the above-described transmission ratio range.

In order to start the internal combustion engine 1, the first MG 60 rotates the internal combustion engine 1 in an applying state of the H-1 mode shown in FIG. 4. The velocity lines at the motor vehicle stopping in the H-1 mode where the internal combustion engine 1 rotates indicate that the first planetary gear set 20 is expressed by al and the second planetary gear set 30 is expressed by a2. At this time, the reaction torque applies to the output shaft 12 due to the torque of the first MG 60, so that the torque is applied by the second MG 62 to cancel the reaction torque as may be necessary.

Then, in order to start the motor vehicle in the H-1 mode, the electric power that the first MG 60 generates is supplied to the second MG 62 in order to output the torque. At this time, when the second MG 62 outputs the torque in the positive rotational direction, it is the advancement H-1 mode, while, when the second MG 62 outputs the torque in the reverse rotational direction, it is the astern H-R mode.

When the velocity increases up to a position where it overlaps at b with the velocity line a2 in the H-1 mode, the third clutch 74 is applied to shift to the first speed of the step drive mode. At this time, it is possible to temporally apply the both of the second clutch 72 and the third clutch 74. Then, the second clutch 72 is released, the first MG 60 shifting toward the reverse rotational direction side, and the first clutch 70 being applied, so that the motor vehicle gets to run at the first speed expressed by the velocity line b. The transmission ratio (the rotational velocity of the input shaft 10/the rotational velocity of the output shaft 12) at the first speed is (1+ρ2)/ρ2, where it becomes 3.667 at the teeth ratios set above.

The drive at the first speed is a mechanical drive where the internal combustion engine 1 drives, but it may add driving torque of the first MG 60 and/or the second MG62 when the electric power of the battery can afford to supply. Possibly, the internal combustion engine 1 drives the first MG 60 and/or the second MG 62 to generate the electric power for charging the battery. This operation is common in mechanical drives which will be described hereinafter.

Next, a shift from the first speed to the second speed will be described. This shift is carried out through the H-2 mode. That is, the first MG 60 generates at the first speed, and its generated electric power is supplied to the second MG 62. In addition, when the first brake 80 is released, the drive mode is shifted to the H-2 mode. The rotational velocity of the first MG 60 gradually moves to zero, and it is the second speed in a state where the first MG 60 is stopped. To keep the first MG 60 stopping at the second speed, the second MG 62 generates somewhat. The transmission ratio at the second speed is 1+ρ1/ρ2(1+ρ1), where it becomes 2.0 at the teeth ratios set above. Incidentally, the second speed is the constant ratio where the first MG 60 is kept stopping, but it is a part of the continuously variable transmission ratio in the H-2 mode.

Next, a shift from the second speed to the third speed starts from rotating the first MG 60 in the positive rotational direction in the H-2 mode. That is, the electric power generated by the second MG 62 is supplied to the first MG 60 so that the rotation velocity of the first MG 60 increases in the positive rotational direction. The 3rd′ mod in FIG. 2 is a state previous to the third speed in the H-2 mode, when the first MG 60 rotates in the positive rotational direction, a relationship between the generation and the drive of the first MG 60 and the second MG 62 becomes reversed while the first speed goes to the second speed, so that G/D and D/G in FIG. 2 express these states.

Then, when the transmission ratio comes close to the third speed, the second clutch 72 is engaged and the third clutch 74 is released. At this time, the both of the second clutch 72 and the third clutch 74 may temporally become engaged. The third speed is expressed by the velocity line d, where the second clutch 72 is switched to be engaged and the rotational velocity of the second MG 62 is zero. The transmission ratio at the third speed is 1+ρ2, where it becomes to 1.375 at the teeth ratios set above. The second MG 62 is kept being stopped at the third speed, so that the first MG 60 generates somewhat.

Next, in order to shift from the third speed to the fourth speed, the electric power generated by the first MG 60 is supplied to the second MG 62 to execute this shift through the H-3 mode where the second MG 62 is rotated in the positive rotational direction. It is the velocity line e where the rotational velocities of the input shaft 10 and the output shaft 12 are equal to each other due to the continuously variable transmission in the H-3 mode. Herein, when the third clutch 74 is engaged, the first planetary gear set 14, the first MG 60 and the second MG 62 drive as one. The transmission ratio is 1, and the motor vehicle is driven at the fourth speed of the mechanical drive.

Next, a shift from the fourth speed to the sixth speed through the fifth speed will be described. The sleeve 78 is moved toward the right side in FIG. 1 in a state of the third speed and the fourth speed. When the third clutch 74 is released from the state of the fourth speed, the motor vehicle runs at the H-3 mode again, and the rotational velocity of the second MG 62 changes higher than that of the input shaft 10. In due time, the transmission ratio that is estimated to be the appropriately middle ratio between the fourth speed and the sixth speed is 0.890 (which is called as the fifth speed), the rotational velocity of any rotational member is not zero unlike the other constant ratios, and so this value of the transmission ratio does not mean anything. At the transmission ratio of the appropriately middle ratio between the fourth speed and the sixth speed, the propelling equipment is shifted to the H-4 mode.

In the H-4 mode, the first MG 60 generates and the second MG 62 drives the motor vehicle, which is carried out the same as in the H-3 mode. The first clutch 70 is, however, released, and the third clutch 74 is applied, so that the second MG 62 is connected with the input shaft 10. Then, the motor vehicle is driven at the H-4 mode, and when the rotational velocity of the first MG 60 becomes zero, the propelling equipment becomes the sixth speed as expressed by the velocity line f1. The sixth speed is a mechanically accelerating drive. At this time, when the third clutch 74 is kept being engaged, the velocity line of the second planetary gear set 30 is expressed by f2, while, when the third clutch 74 is released and the rotation of the second MG 62 is stopped, this velocity line is expressed by f3. That is, f3 is a drive at the six speed in a state where the both of the first MG 60 and the second MG 62 are stopped.

As described above, the continuously variable transmission may be possible in the H-1 mode, the H-2 mode, the H-3 mode and the H-4 mode. In each step drive mode except the fifth speed, the motor vehicle runs at any time, shifting between the continuously variable transmission ratio and the fixed transmission ratio according to a running condition of the motor vehicle.

The above explanation is a case where the motor vehicle starts from the H-1 mode in a state where the internal combustion engine 1 rotates, while the second MG 62 may start the internal combustion engine 1 during running at the E-2 mode, and then the propelling equipment may shift to the H-2 mode or the H-3 mode.

In addition, when the internal combustion engine 1 is stopped during running at the sixth speed for example, the second clutch 72 can be released to become neutral (N) in FIG. 2. When the both of the first MG 60 and the second MG 62 are stopped, the motor vehicle can coast, and at this time, when the third clutch 74 is applied, the second MG 62 may restart the internal combustion engine 1 at any time. Then, by shifting the second clutch 72 from the third clutch 74, the propelling equipment can quickly shift to the sixth speed or the H-4 mode etc.

The above-described explanation concerns to the operation of the first embodiment, and the first embodiment can provide the following advantages. The propelling equipment of the first embodiment has a function as, what is called, an electrical CVT that is capable of transmitting at continuous variable transmission ratio from the start of the motor vehicle to high speed running In addition, the rotational velocity of the MG (the second MG 62 in the first embodiment) can be drastically decreased relative to that of the conventional ones especially at the high speed running.

That is, the sixth speed that is used for many time is an intersection point g where a dashed line expressed by the velocity line f4 in FIG. 4 and the velocity axis M4 in the conventional propelling equipment, while the rotational velocity of the second MG 62 can be zero in the first embodiment. The transmission power of the second MG 62 is very small during high speed running in general, so that a useless high-speed rotation of the second MG 62 can be avoided in the first embodiment, and its loss can be reduced. Accordingly, the fuel consumption at the high speed running can be improved.

In addition, there is a case where acceleration and deceleration are not needed at high speed cruising especially by an auto cruise control system and a small loss in neutral is desired. In the neutral of the first embodiment, the internal combustion engine 1, the first MG 60 and the second MG 62 may be stopped, so that it can decrease a running resistance. This also can improve the fuel consumption.

Furthermore, each step drive mode except the fifth speed is nearly the mechanical drive, and the power transmission efficiency thereof is high. In cooperation with running with selections of optimal drive modes, the fuel consumption can be improved so much relative to that of the conventional propelling equipment.

### Second Embodiment

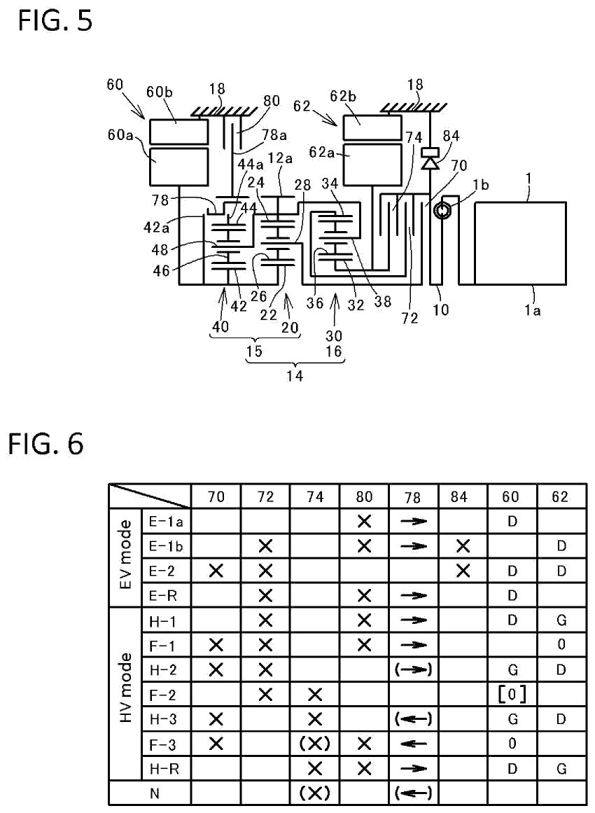

Next, a propelling equipment of the second embodiment according to the invention will be described. FIG. 5 is a skeleton of a main part of the propelling equipment of the second embodiment. Herein, parts of the second embodiment which are different from the first embodiment will be described.

A first difference is that the first planetary gear set 20 is included in the first planetary gear group 15, the second planetary gear set 30 being included in the second planetary gear group 16, and in addition the first planetary gear group 15 including a third planetary gear set 40. Incidentally, the third planetary gear set 40 is a single pinion type similar to those of the first embodiment, and so its detailed description is omitted.

A second difference is that the input shaft 10 is fixable on the case 18 through a one-way clutch (hereinafter referred to as an “OWC”). That is, the input shaft 10 is fixed on case 18 in the reverse rotational direction.

A third difference is that a connecting relationship between the rotational elements and the other rotational members is different as follows. The first sun gear 22 and the third sun gear 42 is connected with each other to function as a first member M1 of the invention. Similarly to the first embodiment, they are connected with the first rotator 60a of the first MG 60, and they are fixable on the case 18 by the first brake 80 through the sleeve 78.

The first carrier 33 and the second ring gear 34 function as a second member of the invention. The first carrier 38 is connectable with the input shaft 10 through the first clutch 70, while the second ring gear 34 is connectable with the input shaft 10 through the second clutch 72.

The first ring gear 24, the second carrier 38 and the third carrier 34 function as a third member of the invention, and they are connected with the output shaft 12.

The second sun gear 32 and the third ring gear 44 function as a fourth member of the invention. The second sun gear 32 is connected with the second rotator 62a of the second MG 62, and it is connectable with the input shaft 10 through the third clutch 74. The third ring gear 44 is fixable on the case 18 by the first brake 80 through the sleeve 78 to function as a low-speed step fixing member of the invention. Similarly to the first embodiment, when the sleeve 78 is moved in the axial direction in FIG. 5, the first member or the low-speed step fixing member are selectively fixed on the case 18.

The teeth ratios of the planetary gear sets 20, 30 and 40 are set as follows: The teeth ratio ρ1 of the first planetary gear set 20 is set to 0.36, the teeth ratio ρ2 of the second planetary gear set 30 is set to 0.60, and the teeth ratio ρ3 of the planetary gear set 40 is set to 0.44, for example.

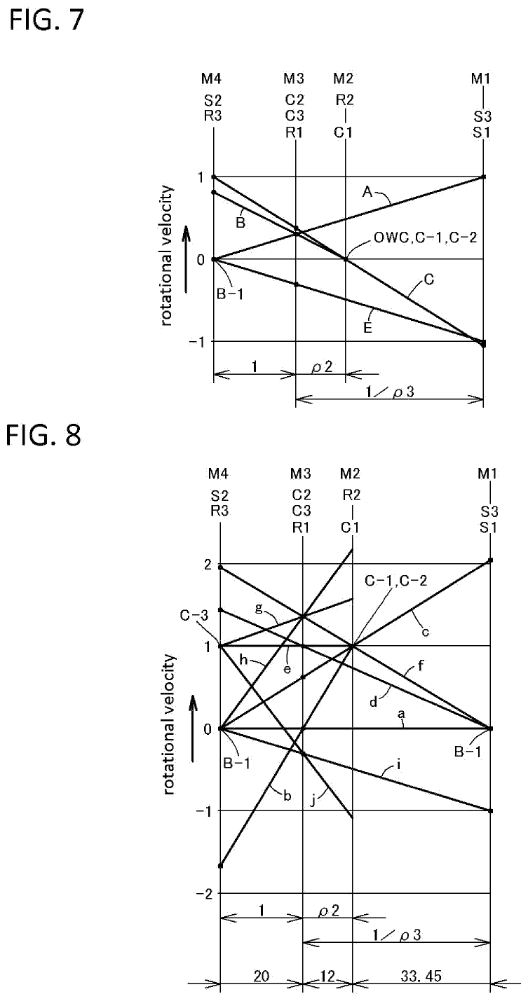

The operation of the second embodiment shown in FIG. 5 will be described with reference to an operational table shown in FIG. 6 and common velocity diagrammatic views shown in FIGS. 7 and 8. Incidentally, in the operational table in FIG. 6, fixed ratio modes of mechanical drives in the HV mode are characterized by an F-1 mode, an F-2 mode and so forth, and a state where the first MG or the second MG is stopped is indicated by

The EV mode includes three drive modes: an E-1 mode, an E-2 mode and an E-3 mode. The E-1 mode has an E-1a mode, where the first brake 80 is applied and the first MG 60 drives as expressed by a velocity line A in FIG. 7, and an E-1b mode, where the input shaft 10 is fixed by the OWC 84 and the second MG 62 drives by engaging the second clutch 72 in addition to the drive of the first MG 60 as expressed by a velocity line B. The transmission ratio (the rotational velocity of the first MG 60/the rotational velocity of the output shaft 12) when the first MG 60 drives the motor vehicle is (1+ρ3)/ρ3, where it becomes 3.27 at the teeth ratios set above. The transmission ratio (the rotational velocity of the second MG 62/the rotational velocity of the output shaft 12) when the second MG 62 drives is (1+ρ2)/ρ2, where it becomes 2.67 at the teeth ratios set above.

The E-1a mode is suitable when the propelling equipment is shifted between the EV mode and a HV-1 mode which will be later described, while the E-1b mode is suitable when large torque is needed in a state where the internal combustion engine 1 is stopped. Incidentally, when first motor 60 rotates in the reverse rotational direction in the connecting relationship at the E-1a mode, the mode becomes the E-R mode where the motor vehicle runs astern as expressed by a velocity line E.

In the E-2 mode expressed by a velocity line C, the input shaft 10 is fixed on the case 18 by the OWC 84, the both of the first clutch 70 and the second clutch 72 being engaged, and one or the both of the first MG 60 and second MG 62 drive the motor vehicle. In this case, the velocity lines of the first planetary gear group 16 and the second planetary gear group 18 are overlapped with each other. The transmission ratio where the first MG 60 drives is −1/ρ1, where it becomes −2.78 at the teeth ratios set above. That is, in order to move the motor vehicle forward, the first MG 60 is rotated in the reverse rotational direction. The transmission ratio when the second MG 64 drives is the same as in the E-1 mode. The E-2 mode is suitable for shifting between the H-2 or H-3, which will be later described, and the EV mode.

Next, the H-V mode will be described with reference to the common velocity diagrammatic view shown in FIG. 8. The H-V mode includes four drive modes: an H-1 mode, an H-2 mode, an H-3 mode and an H-4 mode which can carry out a continuously variable transmission, while the propelling equipment can be driven at the fixed ratio modes F-1, F-2 and F-3 included in the transmission ratio range.

In order to start the internal combustion engine 1, the second clutch 72 is connected and the second MG 62 rotates the internal combustion engine 1 in the positive rotational direction as well as in the H-1 mode. The

H-1 mode can be shifted from the state of the above-described E-1 mode, but herein a start in a state where the internal combustion engine 1 is rotated will be described.

In the H-1 mode, as shown in the operational table of FIG. 6, the both of the first brake 80 and the second clutch 72 are applied, and the first MG 60 drives the motor vehicle. That is, in the common velocity diagrammatic view shown in FIG. 8, when the motor vehicle is stopped, it is a state where the first planetary gear group 16 is indicated by the velocity line a and the second planetary gear group 18 is indicated by the velocity line b. The internal combustion engine 1 drives the second ring gear 34 at the velocity 1, the second MG 62 generates by rotating in the reverse rotational direction to supply its electric power to the first MG 60, and the first MG 60 rotates the first sun gear 22 in the positive rotational direction to drive the motor vehicle.

Therefore, the first carrier 28 and the second carrier 38, which are connected with the output shaft 12, are applied with the torque in the positive rotational direction to move the motor vehicle forward. With the motor-vehicle speed increasing, the rotational velocity of the second MG 62 increases (approaching zero), and at the same time the rotational velocity of the first MG 60 increasing to shift at the continuously variable transmission ratio. The torque of the output shaft 12 at this time is Te(1+ρ2)+Tm1(1+ρ3)/ρ3, where the torque of the internal combustion engine 1 is Te and the torque of the first MG 60 is Tm1.

Incidentally, a description thereafter will be described when the rotational velocity of the input shaft 10 being kept 1 as a matter of convenience. As the motor-vehicle speed increases, the velocity line of the first planetary gear group 16 and the velocity line of the planetary gear group 19 are soon overlapped at a state of c. Herein when the first clutch 70 is engaged, the propelling equipment shifts to the mechanical drive by the internal combustion engine 1. That is, the transmission ratio is 1/(1+ρ3), where it becomes 1.7 at the teeth ratio set above. This is a fixed ratio mode of F-1.

In this state, when the first brake 80 is released, the propelling equipment shifts to the H-2 mode. That is, the input shaft 10 drives the second ring gear 34 and the first carrier 24. Herein as the motor-vehicle speed increases, the rotational velocity of the first MG 60 decreases to generate, and its electric power drives the second MG 62 to increase its rotational velocity and shift to run the motor vehicle at the continuously variable transmission ratio.

As the speed of the motor vehicle further increases, the second clutch 74 is engaged at a state where the rotational velocity of the input shaft 10 becomes the same as that of the output shaft 12. That is, the second sun gear 32 and the second ring gear 34 are connected with the input shaft 10, so that the second planetary gear set 30 is mechanically connected as one with the output shaft and the output shaft 12.

At this time, the first MG 60 may not rotate, and it may be stopped by releasing the first clutch 70. The state where the first MG 60 is stopped at this transmission ratio 1 is indicated by velocity lines d and e, and this is a fixed ratio mode of F-2. Of cause, the second MG 62 is rotating, but it never drives nor generates.

Then, in order to further become the transmission ratio small, the rotational velocity of the first MG 60 is returned to the same as that of the input shaft 10, the second clutch 72 is engaged, and the third clutch 74 is released. This returns the continuously variable transmission mode of H-2 again. After this, as the speed of the motor vehicle goes up, the propelling equipment shifts to the H-3 mode.

The H-3 mode is the drive in a state where the first clutch 70 and the third clutch 74 are engaged together, and the first MG 60 generates and the second MG 62 drives. This is the same as at the H-2 mode, while it is different from the H-2 mode in that the second MG 62 is connected with the input shaft 10. In this H-3 mode, the rotational velocity of the second MG 62 is the same as that of the input shaft 10. As the motor-vehicle speed increases, the rotational velocity of the first MG 60 decreases to shift to run the motor vehicle at the continuously variable transmission ratio. Incidentally, the sleeve 78 is moved toward the right side.

The motor-vehicle speed increases and the transmission ratio becomes small in the H-3 mode, the rotational velocity of the first MG 60 becomes zero, and the first brake 80 fixes the first sun gear 22 on the case 18. This state is indicated by the velocity lines f and g, and this is a fixed ratio mode of F-3. The transmission ratio at this time is 1/(1+ρ1), where it becomes 0.74 at the teeth ratio set above.

In order to shift to the H-3 mode, the propelling equipment may shift from the H-2 mode to the H-3 mode, or it may directly shift from the F-2 mode to the H-3 mode. In addition, it may be possible to drive at the transmission ratio smaller than that at the F-3 mode in the H-3 mode. In this case, the second MG 62 generates and the first MG 60 drives by rotating in the reverse rotational direction.

Though it is described that the first MG 60 and the second MG do not drive at the fixed ratio modes of F-1, F-2, and F-3, in a case where the battery affords to supply the electric power, one of the first MG 60 and the second MG 62 can support the internal combustion engine 1.

Then, the H-R mode of driving astern will be described. In the H-R mode, the first brake 80 and the third clutch 74 are engaged to drive the motor vehicle as shown in the operational table of FIG. 6. That is, the first MG 60 drives as the same as in the E-R mode, and the electric power is generated by the second MG 62 which is directly connected with the internal combustion engine 1. This is a drive called as a series type in general. The velocity lines at the H-R mode in a case where the rotational velocity of first MG 60 is set −1 in FIG. 8.

Next, the neutral (N) during the motor vehicle running will be described. In this case, every fastening elements are released. By this operation, the both of the first MG 60 and the second MG 62 can be stopped. The velocity lines are indicated by f and h in a case where the propelling equipment is neutral in the rotational velocity of the output shaft 12 in the above-described F-3 mode. In order to start the motor vehicle from this neutral state, the third clutch 76 is engaged and the second MG 62 rotates the internal combustion engine 1. Of cause, the third clutch 76 may be kept being engaged in the neutral state. After the internal combustion engine 1 starts, the propelling equipment is shifted to the F-2 mode or any one of the H-3 mode and the H-2 mode.

The operation of the second embodiment is explained in above description, and it is the same as the first embodiment to keep the rotational velocity of the second MG 62 smaller than that of the conventional propelling equipment especially during the high speed running and to run at the mechanical drive in a state where the second MG 62 is stopped. The fuel consumption can be improved by decreasing a loss when the rotational velocity of the second MG 62 is kept zero especially in the F-2 mode of the direct drive and F-3 mode of a speed-increasing drive relative to a case where the second MG 62 rotates. Of cause, the power transmission efficiency is high at the mechanical drive at the fixed ratios, so that it further improves the fuel consumption.

### Third Embodiment

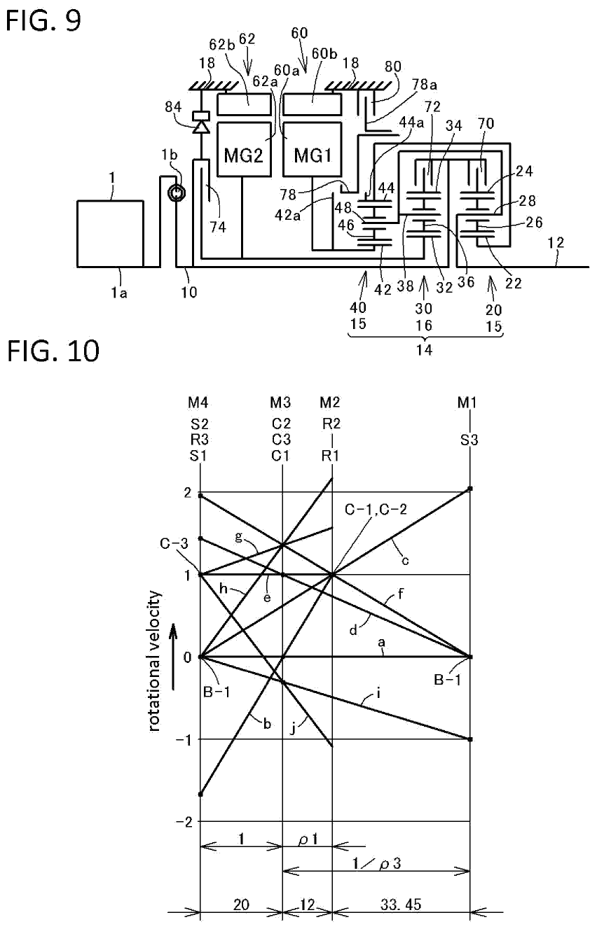

Next, a propelling equipment of a third embodiment according to the invention will be described. FIG. 9 shows a skeleton of a main part of the propelling equipment of the third embodiment. Herein, parts of the third embodiment which are different from the second embodiment will be specifically described.

A first difference between the third embodiment and the second embodiment is that the output shaft 12 is arranged at the side opposite to the internal combustion engine 1 in the axial direction of and rear wheels are driven by the internal combustion engine 1 arranged at a front part of the motor vehicle, what is called, an FR motor vehicle. A second difference is that a connecting relationship of the first planetary gear group 15 and the axial directional arrangement of the first to third planetary gear sets 20, 30 and 40 is different due to the connecting relationship of the first planetary gear group 15.

That is, the first planetary gear set 20 and the third planetary gear set 40 of the first planetary gear group 15 are arranged to be provided oppositely with the second planetary gear set 30. The third sun gear 42 functions as a first member of the invention. The first ring gear 24 and the second ring gear 34 are connected to function as a second member of the invention. The third carrier 48 is connected with the first carrier 28, the second carrier 38 and the output shaft 12 to function as a third member of the invention. The first sun gear 22 is connected with the third ring gear 44 and the second sun gear 32 to function as a fourth member of the invention. The other parts are similar to those of the second embodiment, and its description is omitted.

As the connecting relationship of the first planetary gear group 15 described above is modified from the second embodiment, the common velocity diagrammatic view is different from that of the second embodiment. Herein, on behalf of its drive modes, FIG. 10 shows the HV mode. As shown in FIG. 10, a combination of the rotational members shown at the upper side in FIG. 10 and an expression of the teeth ratios shown at the lower side in FIG. 10 are changed from FIG. 8. Herein, the teeth ratio ρ1 of the first planetary gear set 20 is set to 0.60, so that intervals in the lateral direction of the velocity axes in the common velocity diagrammatic view of FIG. 10 become the same as those in FIG. 8. Incidentally, the common velocity diagrammatic view at the EV mode also changes as well as FIG. 10 in the combination of the rotational members shown in at the upper side and the expression of the teeth ratios shown at the lower side, but its illustration is omitted.

The operation of the third embodiment is basically similar to that of the second embodiment, including the operational table, and therefore its description is omitted.

The third embodiment can provide the advantages similar to those of the second embodiment. In addition, it is suitable for the FR motor vehicle which drives the rear wheels by the internal combustion engine 1 arranged at the front part of the motor vehicle. Further, when it is applied to the FR motor vehicle, high rigidity of the entire of the propelling equipment including the case 18 can be secured as the first MG 60 and the second MG 62 are arranged near the internal combustion engine 1 as shown in FIG. 9.

### Fourth Embodiment

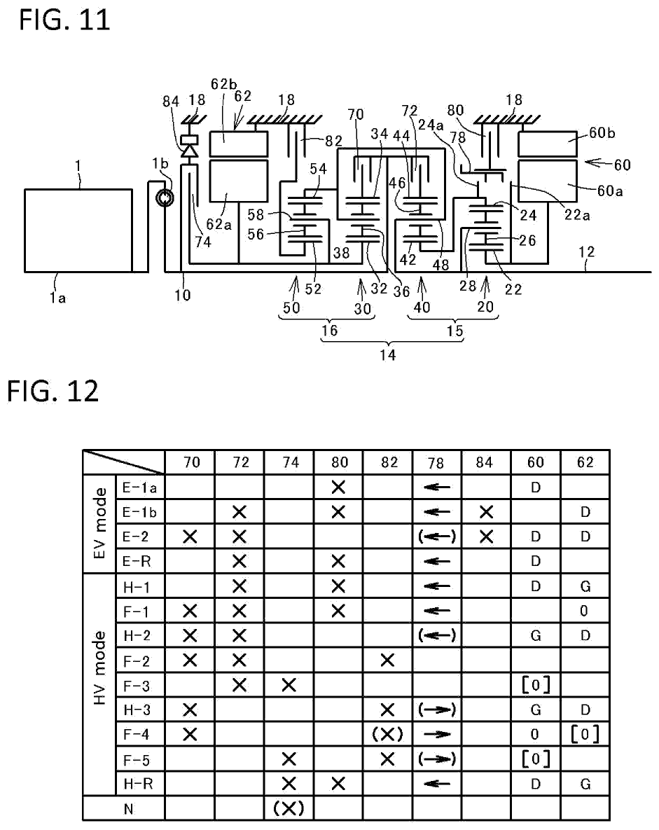

Next, a propelling equipment of a fourth embodiment according to the invention will be described. FIG. 11 shows a skeleton of a main part of the propelling equipment of the fourth embodiment. Herein, parts of the fourth embodiment which are different from the third embodiment will be specifically described.

A first difference between the fourth embodiment and the third embodiment is that the second planetary gear group 16 is composed of the second planetary gear set 30 and a fourth planetary gear set 50. This added fourth planetary gear set 50 has three rotational elements: a fourth sun gear 52, a fourth ring gear 54 and a fourth carrier 58 rotatably supporting a plurality of fourth pinions 56 engaged with the fourth sun gear 52 and the fourth ring gear 54. The fourth sun gear 52 is fixable on the case 18 by a second brake 82 to function as a fifth member M5 of the invention. The fourth carrier 58 is connected with the third sun gear 42 to function as a fourth member of the invention. The fourth ring gear 54 is connected with the output shaft 12 to function as a third member of the invention. The third ring gear 44 and the second ring gear 34 function as a second member of the invention. The first sun gear 22 functions as a first member of the invention. The first to fifth members are aligned in order on the lateral axis of the common velocity diagrammatic view toward the right side or the left side.

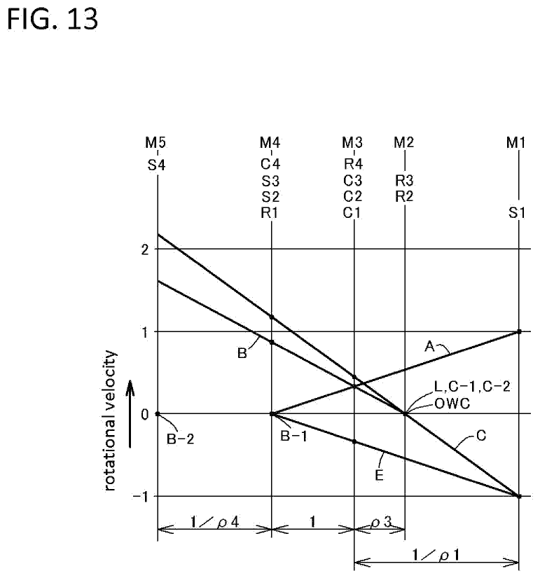

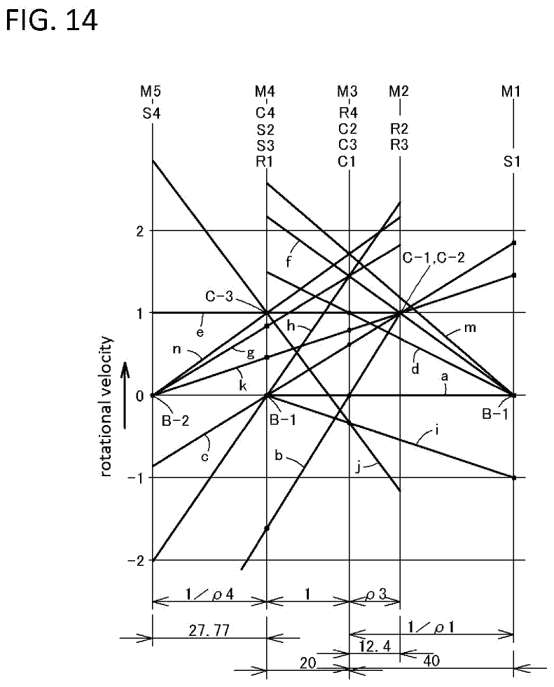

With regard to the operation of the fourth embodiment, an operational table is indicated by FIG. 12, a common velocity diagrammatic view at the EV mode is indicated by FIG. 13, and a common velocity diagrammatic view at the HV mode is indicated by FIG. 14. The operational table shown in FIG. 12 is basically illustrated similarly to that of the second embodiment. In addition, the teeth ratios of the first to fourth planetary gear sets 20, 30, 40 and 50 in FIGS. 13 and 14 are set as follows. The teeth ratio ρ1 of the first planetary gear set 20 is set to 0.5, the teeth ratio ρ2 of the second planetary gear set 30 is set to 0.62, the teeth ratio ρ3 of the third planetary gear set 40 is set to 0.62 as well as ρ2, and the teeth ratio ρ4 of the fourth embodiment 50 is set to 0.72.

A difference of the operation between the both of the second embodiment, the third embodiment and the fourth embodiment is a part relating to the fourth planetary gear set 50 and the second brake 82, and so this part will be specifically described. First, the EV mode does not relate to the operation of the fourth planetary gear set 50 and the second brake 82, and the transmission ratio can be geometrically computed from FIG. 13. Therefore, its description is omitted.

Then, the HV mode will be described with reference to the common velocity diagrammatic view of FIG. 14. The HV mode has four drive modes: an H-1 mode, an H-2 mode, an H-3 mode and an H-R mode. In these modes, the propelling equipment can run at the continuously variable ratio, and it can also run at the fixed ratio modes of F-1, F-2, F-3, F-4 and F-5 as described in the second embodiment. The H-1 mode and the F-1 mode are similar to those of the second embodiment, and its description is omitted. The transmission ratio at the F-1 mode becomes 1.62 at the teeth ratios set above.

In the H-2 mode, the fastening elements are changed in the F-1 mode as well as the second embodiment, and the propelling equipment transfers to the continuously variable transmission ratio in a transmission ratio range narrower than the transmission ratio of the F-1 mode. Then, it shifts to the F-2 mode as indicated by the velocity line k. At the F-2 mode, the second brake 82 is applied in addition to the engagement of the first clutch 70 and the second clutch 74 to drive at the mechanical drive. The transmission ratio is {1+ρ4(1+ρ2)}/(1+ρ4), where it becomes 1.26 at the teeth ratios set above.

The F-2 mode is a drive at the fixed ratio in the transmission ratio range of the H-2 mode. The propelling equipment may be driven at the F-2 mode, or the application of the second brake 82 may be omitted as a pass point of the transmission ratio of the H-2 mode. Soon it shifts to the F-3 mode as indicated by the velocity line e.

The F-3 mode indicated by the velocity line e is similar to the F-2 mode of the second embodiment. The input shaft 10 and the output shaft 12 is mechanically connected with each other. The transmission ratio is 1. The F-3 mode is a drive at the fixed ratio in the transmission ratio range of the H-2 mode. The propelling equipment may drive at the continuously variable transmission ratio after returning to the H-2 mode, or shift to the next H-3 mode.

At the H-3 mode, the first clutch 70 is engaged and the second brake 82 is applied. The first MG 60 generates and the second MG 62 drives at the continuously variable transmission ratio. At this time, the second MG 62 drives the output shaft 12 at a speed-increasing ratio as well as the F-4 mode, which will be later described, differently from the second embodiment.

The F-4 mode indicated by the velocity line f is a state where the rotational velocity of the first MG 60 becomes zero in the H-3 mode as well as the F-3 mode of the second embodiment. The motor vehicle is driven by a mechanical drive at the fixed ratio in the transmission ratio range of the H-3 mode. At the F-4 mode, the second brake 82 may be applied, the velocity line of the second planetary gear group 15 being g. Or the second brake 82 may be released and the second MG 62 may be stopped. The transmission ratio of the F-4 mode is the same as that of the F-3 mode of the second embodiment. It becomes 0.69 at the teeth ratios set above.

When the transmission ratio in the H-3 mode becomes smaller than that in the F-4 mode, the second MG generates 62 generates and the first MG 60 drives in the reverse rotational direction, conversely in the operational table shown in FIG. 10. As the transmission ratio further becomes small and the rotational velocity of the fourth sun gear 52 becomes zero, the first clutch 70 is disengaged and the second brake 82 is applied. This is the F-5 mode indicated by the velocity lines m and n. The F-5 mode is the mechanical drive, and its transmission ratio is 1/(1+ρ4), where it becomes 0.58 at the teeth ratios set above. In the F-5 mode, the first MG 60 may be stopped.

In the drives at the fixed ratio modes of F-1 to F-5, one of the first MG 60 and the second MG 62 can aid the drive as well as described in the second embodiment. The neutral and the H-R mode are similar to those of the second embodiment, and its description is omitted.

The operation has been described in the above explanation, and the fourth embodiment has the same advantages as those of the first embodiment to the third embodiment in addition to the following ones. It is the same as the second embodiment that the three drive modes at the continuously variable transmission ratios of the H-1 mode, the H-2 mode and the H-3 mode in the HV mode, and the rotational velocity of the second MG 62 at the H-3 mode can be small much more. That is, as the second MG 62 drives the output shaft 12 at the speed-increasing ratio in the second embodiment, the rotational velocity of the second MG 62 of the third embodiment is smaller than that of the second embodiment in comparison with a state at the same transmission ratio. Thus, the rotational loss of the second MG 62 decreases, and the power transmission efficiency can be improved.

In addition, the propelling equipment has two steps of the F-4 mode and the F-5 mode as the mechanical drives that are suitable for high speed running, so that the fuel consumption especially at the high speed miming is improved. Furthermore, as the propelling equipment has five steps of the mechanical drives at the five transmission ratios of the F-1 to F-5 modes, the number of the selected modes suitable for the optimal driving condition of the motor vehicle can be increased, and it is possible to run the motor vehicle at a better fuel consumption.

As described above, the propelling equipment of the invention has the advantage in that the fuel consumption is superior especially at steady running and high speed running. In addition, the above-described construction can be achieved by providing at least four rotational members of planetary gear trains different from the planetary gear trains shown in FIGS. 1, 5, 9 and 11.

Furthermore, a detail construction is omitted, but an operational combination different from the fastening elements and MGs of the first to fourth embodiments can drive at different modes. For example, the H-R mode of the second to the fourth embodiment is a series type drive, and this construction can be used for running forward.

Furthermore, a part of the fastening elements can be replaced by a mechanical dog clutch. The first MG 60 can be constructed by a permanent magnet type motor, and the second MG 62 can be constructed by an induction type motor.

While there have been particularly shown and described with reference to preferred embodiments thereof, it will be understood that various modifications may be made therein, and it is intended to cover in the appended claims all such modifications as fall within the true spirit and scope of the invention.

The entire contents of Japanese Patent Applications No. 2018-096083 filed May 18, 2018 and No. 2018-126587 filed Jul. 3, 2018 are incorporated herein by reference.

What is claimed is:

1. A propelling equipment for a motor vehicle comprising:
an internal combustion engine;
an input shaft that is capable of receiving power from the internal combustion engine;
an output shaft;
a case having a stationary part;
a first motor/generator;
a second motor/generator; and
a planetary gear train that is arranged between the input shaft and the output shaft, the planetary gear train being capable of changing a rotational velocity of the input shaft to a rotational velocity of the output shaft, the planetary gear train having a first planetary gear group that includes a first planetary gear set and a second planetary gear group that includes second planetary gear set, and the first planetary gear group and the second planetary gear group being provided with at least three rotational elements, respectively,
the propelling equipment characterized in that
the rotational elements of the first planetary gear group and the second planetary gear group are combined to correspond to at least four rotational members so that rotational velocities of the rotational members are geometrically expressed by a common velocity diagrammatic view, the velocity axes expressing the rotational members being arranged along on a lateral axis of the common velocity diagrammatic view from one edge to the other edge at intervals according to teeth ratios of the planetary gear sets so that the velocity axes are set as a first member, a second member, a third member and a fourth member from the one edge to the other edge in order in the common velocity diagrammatic view, wherein
the rotational members of the first planetary gear group are constructed so that the first member is connected with the first motor/generator, the second member being connectable with the input shaft, and the third member being connected with the output shaft, wherein
the rotational members of the second planetary gear group are constructed so that one of the rotational members corresponds to the second member, one of the rotational members corresponding to the third member, and one of the rotational members corresponding to the fourth member connected with the second motor/generator, wherein
one of the second member and the fourth member corresponds to a low-seed step fixed ratio member, a fixed transmission ratio at the low-speed step being obtained by fixing the low-seed step fixed ratio member on the stationary part, and wherein
the fourth member is fixable to the stationary part when the first member is fixed on the stationary part or rotates at a low speed to obtain a speed increasing transmission ratio.

2. The propelling equipment according to claim 1, wherein
the fourth member is selectively fixed on the stationary part or connected when the first member is fixed on the stationary part or runs at low speed rotation to obtain the speed-increasing transmission ratio.

3. The propelling equipment according to claim 2, further comprising:
a first brake provided on the stationary part; and
a sleeve provided among the first brake, the first member and the low-speed step fixed member, wherein
the first member and the low-speed step fixed member are selectively fixable on the stationary part.

4. The propelling equipment according to claim 3, wherein
the planetary gear train includes a first planetary gear set having the three rotational elements of a first sun gear, a first ring gear and a first carrier and a second planetary gear set having the three rotational elements of a second sun gear, a second ring gear and a second carrier, wherein
the first sun gear corresponds to the first member, wherein
the first carrier and the second ring gear are connectable with each other to correspond to the second member, wherein
the first carrier is connectable with the input shaft, wherein
the second ring gear corresponds to the low-speed step fixed member, wherein
the first ring gear and the second carrier correspond to the third member, and wherein
the second sun gear corresponds to the fourth member.

5. The propelling equipment according to claim 4, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

6. The propelling equipment according to claim 2, wherein
the second member, the third member and the fourth member are constructed in such a way that the first planetary gear group has the first planetary gear set and a third planetary gear set including three rotational elements, the secondary planetary gear group having at least the second planetary gear set, at least the first to fourth rotational members being constructed by combining the rotational elements of the first planetary gear group, and the rotational element of the second planetary gear set being connected or connectable with the rotational elements of the first planetary gear group.

7. The propelling equipment according to claim 3, wherein
the second member, the third member and the fourth member are constructed in such a way that the first planetary gear group has the first planetary gear set and a third planetary gear set including three rotational elements, the secondary planetary gear group having at least the second planetary gear set, at least the first to fourth rotational members being constructed by combining the rotational elements of the first planetary gear group, and the rotational element of the second planetary gear set being connected or connectable with the rotational elements of the first planetary gear group.

8. The propelling equipment according to claim 7, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

9. The propelling equipment according to claim 2, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

10. The propelling equipment according to claim 1, further comprising:
a first brake provided on the stationary part; and
a sleeve provided among the first brake, the first member and the low-speed step fixed member, wherein
the first member and the low-speed step fixed member are selectively fixable on the stationary part.

11. The propelling equipment according to claim 10, wherein
the planetary gear train includes a first planetary gear set having the three rotational elements of a first sun gear, a first ring gear and a first carrier and a second planetary gear set having the three rotational elements of a second sun gear, a second ring gear and a second carrier, wherein
the first sun gear corresponds to the first member, wherein
the first carrier and the second ring gear are connectable with each other to correspond to the second member, wherein
the first carrier is connectable with the input shaft, wherein
the second ring gear corresponds to the low-speed step fixed member, wherein
the first ring gear and the second carrier correspond to the third member, and wherein
the second sun gear corresponds to the fourth member.

12. The propelling equipment according to claim 11, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

13. The propelling equipment according to claim 10, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

14. The propelling equipment according to claim 13, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

15. The propelling equipment according to claim 1, wherein
the planetary gear train includes a first planetary gear set having the three rotational elements of a first sun gear, a first ring gear and a first carrier and a second planetary gear set having the three rotational elements of a second sun gear, a second ring gear and a second carrier, wherein
the first sun gear corresponds to the first member, wherein
the first carrier and the second ring gear are connectable with each other to correspond to the second member, wherein
the first carrier is connectable with the input shaft, wherein
the second ring gear corresponds to the low-speed step fixed member, wherein
the first ring gear and the second carrier correspond to the third member, and wherein
the second sun gear corresponds to the fourth member.

16. The propelling equipment according to claim 15, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.

17. The propelling equipment according to claim 1, wherein
the second member, the third member and the fourth member are constructed in such a way that the first planetary gear group has the first planetary gear set and a third planetary gear set including three rotational elements, the secondary planetary gear group having at least the second planetary gear set, at least the first to fourth rotational members being constructed by combining the rotational elements of the first planetary gear group, and the rotational element of the second planetary gear set being connected or connectable with the rotational elements of the first planetary gear group.

18. The propelling equipment according to claim 17, wherein
the second planetary gear group includes the second planetary gear set and a fourth planetary gear set having three rotational elements, wherein
the rotational elements of the second planetary gear group are combined to correspond to the four rotational member, wherein
three of the four rotational members are connected or connectable with the second member of the first planetary gear group, the third member and the fourth member, wherein
the one of the four rotational members corresponds to a fifth member following next to the fourth member in the common velocity diagrammatic view, and wherein
the fifth member is fixable on the stationary part.
